(19) United States
(12) Patent Application Publication
(10) Pub. No.: US 2007/0205218 A1
(43) Pub. Date: Sep. 6, 2007

(54) CONCENTRATE CARTRIDGE

(76) Inventors: Edward L. Mueller, Toledo, OH (US); Douglas F. Taylor, Toledo, OH (US); R. Bruce Yacko, Toledo, OH (US)

Correspondence Address: FRASER CLEMENS MARTIN & MILLER LLC, 28366 KENSINGTON LANE, PERRYSBURG, OH, 43551, US

(21) Appl. No.: 11/677,775

(22) Filed: Feb. 22, 2007

Related U.S. Application Data
(60) Provisional application No. 60/778,206, filed on Mar. 2, 2006.

(51) Int. Cl. B67D 5/56

(52) U.S. Cl. 222/129

(57) ABSTRACT

A reusable concentrate cartridge adapted to be supporting between a diluent container for combining at least two separate components of a multi-component system and an associated dispenser is disclosed. The concentrate cartridge is provided with a hollow cylindrical body and a hollow tube with a closure portion. The concentrate cartridge is caused to open by the rotating engagement of a closure cap on a dispensing sprayer which causes the closure portion of the hollow tube to disengage and release the concentrate material into the diluent container.

### CROSS-REFERENCE TO RELATED APPLICATION

This application claims the benefit of U.S. Provisional Patent Application Ser. No. 60/778,206 filed Mar. 2, 2006.

### FIELD OF THE INVENTION

The invention relates to a concentrate cartridge for a diluting and dispensing container and more particularly to a concentrate cartridge for use in a diluting and dispensing container for combining a concentrate with a liquid diluent which cartridge is reusable and typically fabricated from a readily recyclable material.

### BACKGROUND OF THE INVENTION

Representative of the most current and advanced state of the art is the concentrate cartridge illustrated and described in U.S. Pat. No. 6,290,100 entitled “Concentrate Cartridge for a Diluting and Dispensing Container” issued in the names of R. Bruce Yacko and Edward L. Mueller incorporated herein by reference in its entirety.

The combination of the concentrate cartridge and the dispensing container includes a hollow bottle for containing a liquid diluent having a neck portion for supporting a concentrate cartridge for containing a concentrate, wherein the cartridge comprises a hollow cylindrical element having a first open end forming a closure seat and a second end including a flange extending outwardly of the cylindrical element, an annular collar, and an annular web having a U-shaped cross-section interconnecting the collar and the flange of the first cylindrical element, and a hollow tube having a first end portion in fluid-tight sliding relation with the annular collar of the hollow cylindrical element, and a second end terminating in a radially outwardly extending closure adapted to selectively seat with the closure seat of the hollow cylindrical element to form a fluid-tight closure therebetween; a closure cap including a dispensing means and means to mate with the neck portion of the hollow bottle to provide a tight seal; and a dip tube communicating with the dispensing means inserted through the hollow cylindrical element of the cartridge, and into the hollow bottle.

It would be desirable to produce a concentrate cartridge capable of handling an increased volume of concentrate without the requirement of an increased diameter of the hollow bottle for a diluting and dispensing container.

It would also be desirable to produce a concentrate cartridge which would be readily adaptable to be received and utilized with a broad range of diluent containers and dispensers.

### SUMMARY OF THE INVENTION

Harmonious with the present invention, a concentrate cartridge which would be readily adaptable to be received and utilized with a broad range of diluent containers and dispensers, has surprisingly been discovered.

The above objectives, as well as others, may typically be achieved by a concentrate cartridge comprising: a hollow main body having a first open end forming a closure seat and a spaced apart second end; a hollow tube having a first end portion in substantially fluid-tight sliding relation with the main body, and a second end portion including a closure adapted to selectively seat with the closure seat of the main body to form a substantially fluid-tight closure therebetween; a means for coupling the first open end of the main body to a diluting and dispensing container; and a means for coupling the second end of the main body to a dispensing sprayer.

The above objects, as well as others, may further be achieved by a concentrate cartridge comprising: a hollow main body having a first open end forming a closure seat and a spaced apart second end including a neck finish, an annular collar, and an annular web having a generally U-shaped cross-section interconnecting the annular collar and the neck finish of the first cylindrical element; a hollow tube having a first end portion in substantially fluid-tight sliding relation with the main body, and a second end portion including a closure adapted to selectively seat with the closure seat of the main body to form a substantially fluid-tight closure therebetween; a means for coupling the first open end of the main body to a diluting and dispensing container; and a means for coupling the second end of the main body to a dispensing sprayer; wherein the main body is disposed between the diluting and dispensing container and the dispensing sprayer.

The above objects, as well as others, may yet further be achieved by a hollow cylindrical main body having a first open end forming a closure seat and a second end including a neck finish, an annular collar, and an annular web having a generally U-shaped cross-section interconnecting the collar and the finish of the first cylindrical element; a hollow tube having a first end portion in substantially fluid-tight sliding relation with the annular collar of the main body, and a second end portion terminating into a radially outwardly extending closure adapted to selectively seat with the closure seat of the main body to form a substantially fluid-tight closure therebetween; and a cap attached to the first open end of the hollow cylindrical element for attachment to the finish of a diluting and dispensing container.

### BRIEF DESCRIPTION OF THE DRAWINGS

The above, as well as other, objects and advantages of the invention will become readily apparent to one skilled in the art from reading the following detailed description of the invention when considered in the light of the accompanying drawings, in which:

FIG. 1 is an elevational view partially in section of a concentrate cartridge incorporating the features of the present invention;

FIG. 2 is an elevational view partially in section of an alternative embodiment of the cartridge illustrated in FIG. 1; and

FIG. 3 is an elevational view partially in section of another embodiment of the cartridge illustrated in FIGS. 1 and 2.

### DETAILED DESCRIPTION OF THE PREFERRED EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner.

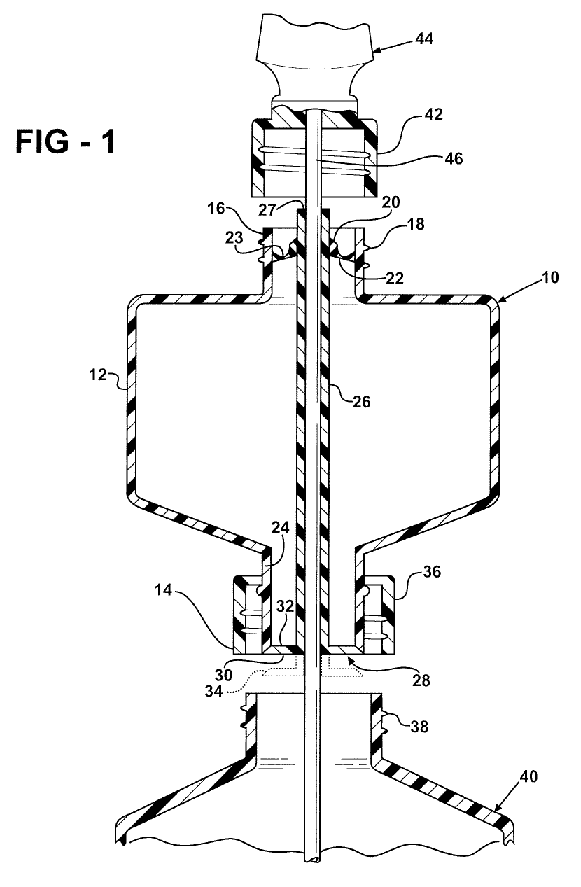

Referring to FIG. 1 of the drawings, there is shown a concentrate cartridge 10 having a hollow cylindrical main body 12. In the embodiment shown, the concentrate cartridge 10 is formed from plastic. It is understood that any suitable material can be used to produce the concentrate cartridge 10 as desired. A lower end 14 of the main body 12 is open. The opposite end is provided with an upwardly extending neck finish 16 having threads 18 formed on an exterior surface thereof. Optionally, an outer surface of the main body 12 may include one or more outwardly extending ridges (not shown) to facilitate a gripping thereof by a user.

The upper end of the neck finish 16 includes an annular collar 20 which is interconnected to an inner portion of the neck finish 16 by an annular web 22. It will be observed that the inner surface of the neck finish 16, the annular web 22, and the outer surface of the annular collar 20 form a trough 23 which is generally U-shaped in cross-section.

The lower end 14 of the main body 12 is provided with a reduced diameter downwardly extending cylindrical portion 24.

The concentrate cartridge 10 includes an associated closure member comprised of a hollow tube 26 having an open first end portion 27 and a radially outwardly extending closure 28 at a second end portion thereof. An outer surface of the first end portion 27 slidable and sealingly engages the annular collar 20 of the neck finish 16 to create a substantially fluid tight seal therebetween. The closure 28 is formed with a generally flat outer surface 30 and an opposing inner surface 32. An outer peripheral surface of the inner surface 32 is provided with a sealing surface 34.

The downwardly extending cylindrical portion 24 of the concentrate cartridge 10 is provided with a closure cap 36 which may be rotatingly coupled to a neck finish 38 of an associated diluting and dispensing container 40.

In operation, the concentrate cartridge 10, filled with the desired concentrate, is attached to the diluting and dispensing container 40. The closure cap 30 :is tightened on the neck finish 38 of the diluting and dispensing container 40, causing a fluid-tight coupling between the concentrate cartridge 10 and the diluting and dispensing container 40 to be established.

Next, a closure cap 42 of an associated dispensing sprayer 44 is suitably tightened on the threads 18 formed on the neck finish 16 of the concentrate cartridge 10. This procedure is initiated by inserting a depending dip tube 46 of the dispensing sprayer 44 into the hollow tube 26. When the dip tube 46 is fully inserted, the closure cap 42 of the dispensing sprayer 44 is tightened, causing an inner surface of the closure cap 42 to engage the first end portion 27 of the hollow tube 26. This forces the tube 26 to be slid downwardly and simultaneously moves the closure 28 to an open position by disengaging the sealing surface 34 from the seated position against the lower end 14 of the main body 12 of the concentrate cartridge 10. The open position is illustrated in the FIG. 1 with dashed lines, and the closed position is illustrated in FIG. 1 with solid lines. Thereby, the concentrate within the concentrate cartridge 10 is released into the diluting and dispensing container 40 and combined with any diluent contained in the diluting and dispensing container 40.

Undesirable leakage of the concentrate from the concentrate cartridge 10 is minimized by the substantially fluid tight seal between the annular collar 20 of the neck finish 16 and the tube 26, and between the closure 28 of the tube 26 and the lower end 14 of the main body 12 of the concentrate cartridge 10.

It will be noted that the present invention permits the main body 12 of the concentrate cartridge 10 to be produced in a wide number of shapes and of differing capacities and, nevertheless, be utilized in the same dispensing sprayer 44 and diluting and dispensing container 40. This feature is particularly advantageous to a retailer who may wish to handle the sale of concentrate containers obtained from a number of different sources. Further, the concentrate cartridge 10 may be refilled with concentrate and reused.

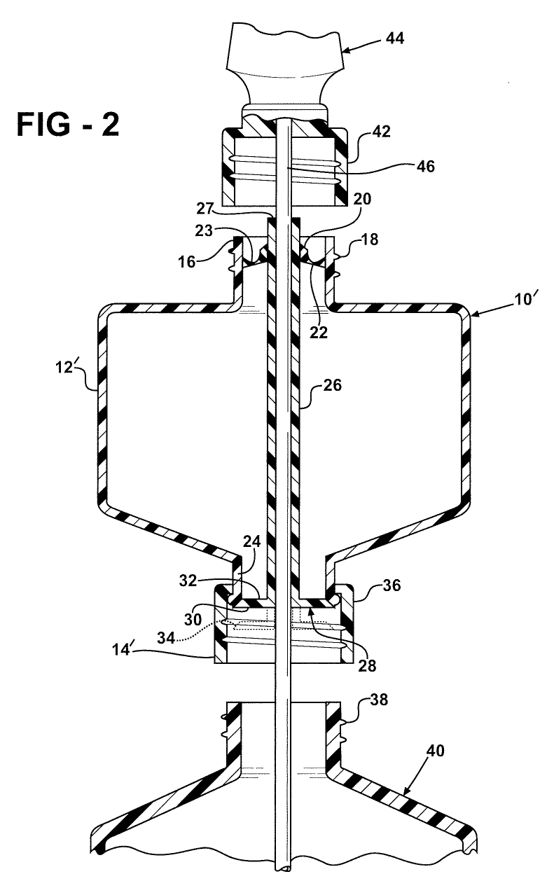

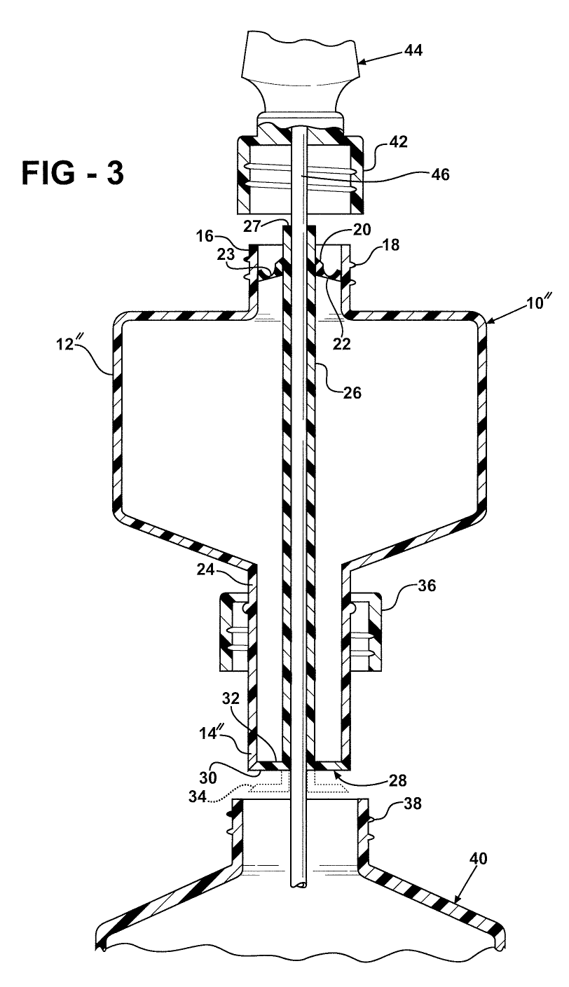

Referring to FIGS. 2 and 3, like reference numerals are used to designate corresponding elements as shown in the embodiment illustrated in FIG. 1, and similar elements are designated by numbers followed by a prime “′” symbol. Only the modified similar elements will be described.

In FIG. 2, there is illustrated an embodiment of the invention illustrated in FIG. 1, wherein a downwardly extending cylindrical portion 14′ of a main body 12′ of a concentrate cartridge 10′ does not extend into the closure cap 30.

In the embodiment illustrated in FIG. 3, a lower end 14″ of a main body 12″ of a concentrate cartridge 10″ extends downwardly from the closure cap 36 and into the hollow interior of the diluting and dispensing container 40 when assembled.

Use of the concentrate cartridges 10′, 10″ is substantially the same as use of the concentrate cartridge 10 described above for FIG. 1.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A concentrate cartridge comprising:
a hollow main body having a first open end forming a closure seat and a spaced apart second end;
a hollow tube having a first end portion in substantially fluid-tight sliding relation with the main body, and a second end portion including a closure adapted to selectively seat with the closure seat of the main body to form a substantially fluid-tight closure therebetween;
a means for coupling the first open end of the main body to a diluting and dispensing container; and
a means for coupling the second end of the main body to a dispensing sprayer.

2. The concentrate cartridge according to claim 1, wherein the second end of the main body includes a neck finish having threads formed on an exterior surface thereof.

3. The concentrate cartridge according to claim 2, wherein the second end of the main body includes an annular collar formed thereon.

4. The concentrate cartridge according to claim 3, wherein an annular web interconnects the annular collar and the neck finish.

5. The concentrate cartridge according to claim 1, further comprising a threaded cap attached to the first open end of the main body for coupling the main body to a neck finish of the diluting and dispensing container.

6. The concentrate cartridge according to claim 1, wherein the concentrate cartridge is formed from plastic.

7. The concentrate cartridge according to claim 1, wherein the closure of the second end of the hollow tube has a sealing surface formed thereon.

8. The concentrate cartridge according to claim 1, further comprising a means for unseating the closure of the hollow tube from the closure seat of the main body.

9. The concentrate cartridge according to claim 8, wherein means for unseating the closure of the hollow tube from the closure seat of the main body is the coupling of the second end of the main body to the dispensing sprayer.

10. The concentrate cartridge according to claim 1, wherein the main body is disposed between the diluting and dispensing container and the dispensing sprayer.

11. A concentrate cartridge comprising:
a hollow main body having a first open end forming a closure seat and a spaced apart second end including a neck finish, an annular collar, and an annular web having a generally U-shaped cross-section interconnecting the annular collar and the neck finish of the first cylindrical element;
a hollow tube having a first end portion in substantially fluid-tight sliding relation with the main body, and a second end portion including a closure adapted to selectively seat with the closure seat of the main body to form a substantially fluid-tight closure therebetween;
a means for coupling the first open end of the main body to a diluting and dispensing container; and
a means for coupling the second end of the main body to a dispensing sprayer; wherein the main body is disposed between the diluting and dispensing container and the dispensing sprayer.

12. The concentrate cartridge according to claim 11, wherein the second end of the main body includes a neck finish having threads formed on an exterior thereof.

13. The concentrate cartridge according to claim 11, further comprising a threaded cap attached to the first open end of the main body for coupling the main body to a neck finish of the diluting and dispensing container.

14. The concentrate cartridge according to claim 11, wherein the concentrate cartridge is formed from plastic.

15. The concentrate cartridge according to claim 11, wherein the closure of the second end of the hollow tube has a sealing surface formed thereon.

16. The concentrate cartridge according to claim 11, further comprising a means for unseating the closure of the hollow tube from the closure seat of the main body.

17. The concentrate cartridge according to claim 16, wherein means for unseating the closure of the hollow tube from the closure seat of the main body is the coupling of the second end of the main body to the dispensing sprayer.

18. A concentrate cartridge comprising:
a hollow cylindrical main body having a first open end forming a closure seat and a second end including a neck finish, an annular collar, and an annular web having a generally U-shaped cross-section interconnecting the collar and the finish of the first cylindrical element;
a hollow tube having a first end portion in substantially fluid-tight sliding relation with the annular collar of the main body, and a second end portion terminating into a radially outwardly extending closure adapted to selectively seat with the closure seat of the main body to form a substantially fluid-tight closure therebetween; and
a cap attached to the first open end of the hollow cylindrical element for attachment to the finish of a diluting and dispensing container.

19. The concentrate cartridge according to claim 18, wherein the neck finish of the second end of the main body is adapted to be coupled to a dispensing sprayer.

20. The concentrate cartridge according to claim 19, wherein the main body is disposed between the diluting and dispensing container and the dispensing sprayer.
